(19) United States
(12) Patent Application Publication
(10) Pub. No.: US 2007/0009636 A1
(43) Pub. Date: Jan. 11, 2007

(54) Methods and systems to enhance foam generation and quality through dispenser

(76) Inventors: Alexander A. Sher, Danbury, CT (US); Jonathan Gray, Mundelein, IL (US); Simon J. Livings, Lausanne (CH); Beli Thakur, New Milford, CT (US); Elaine Wedral, Sherman, CT (US)

Correspondence Address: BELL, BOYD & LLOYD LLC, P. O. BOX 1135, CHICAGO, IL, 60690-1135, US

(21) Appl. No.: 11/178,873

(22) Filed: Jul. 11, 2005

(51) Int. Cl. C12G 1/06

(52) U.S. Cl. 426/477

(57) ABSTRACT

Methods for generating an improved quality foam for a beverage are presented. In an embodiment, the method comprises providing at least one protein source; providing at least one multivalent ion source; providing a liquid source separate from the multivalent ion source; simultaneously dispensing the protein source and the multivalent ion source with the liquid source; and aerating during the dispensing to produce the stable foam. The foam has an improved stability, texture and mouthfeel.

### BACKGROUND OF THE INVENTION

The present invention relates generally to beverages. More specifically, the present invention relates to methods for producing an improved quality foam in a beverage.

Beverages having foam are well known products. Foamed beverages include, for example, coffee beverages such as cappuccinos. These products may typically comprise dry mixes or solutions of a soluble coffee powder and a soluble whitener powder or liquid creamer.

The soluble whitener powder may be a protein-based food product, for example, containing milk or the like. The soluble whitener powder contains pockets of gas that produce foam upon dissolution of the powder when mixed with water. Mixing this soluble whitener powder with a coffee product in liquid, for example, forms a whitened coffee beverage that has foam on its upper surface.

Consumers drinking foamed beverages enjoy the additional aesthetic and taste characteristics that accompany the beverages having a foamed topping. Usually for dispensed foamed/frothed beverages, e.g. cappuccino type, a quality foam needs to be generated in a very short period of time and should be stable during a reasonable period of time so the consumer can enjoy the foam while drinking the beverage. Nevertheless, the typical quality and stability of the foam arising from current soluble whitener powders or liquid creamers is poor. Further, the bubble size distribution is often very inhomogeneous, and the foam texture is poor, soapy and not stiff enough. The foam typically dissipates too quickly and lasts too short of a period of time for consumers to enjoy.

It is therefore desirable to improve the foam quality of food products such as beverages having foam.

### SUMMARY OF THE INVENTION

The present invention generally relates to improved foam products and methods for producing same. In an embodiment, the method generally relates to the use of protein/multivalent cations whereby a beverage product is mixed, whipped, aerated or sheared, and foam is generated having a heightened volume and improved texture.

In an embodiment, a system is provided comprising a powdered protein source to which a multivalent ion source such as calcium salt is added at the point of mixing/aeration. The mixture is designed to be reconstituted with a liquid such as hot water. The powdered protein source and multivalent ion source can be a dry blend. The system can serve to improve the foam of foaming product from a dispensing machine or from a consumer stirring to foam the foaming product.

In another embodiment, the calcium ion source is chemically separated from both protein and reconstituting liquid (water) sources.

In another embodiment, the system can comprise the powdered protein source and multivalent ion source stored and mixed just prior to being reconstituted.

In another embodiment, the system can comprise a liquid protein concentrate and a dray or concentrated multivalent ion source separately stored.

In an embodiment, the method comprises combining a multivalent cation source (such as calcium or magnesium ions source) and a protein source, adding them during reconstitution and aerating with a diluent (e.g., water), for example, by whipping to form the final foamed liquid beverage product.

In an embodiment, the method comprises: providing at least one foaming source; providing at least one multivalent ion source; providing a liquid source separate from the multivalent ion source; combining the foaming source, the multivalent ion source and the liquid source at the point of aerating to produce the improved quality foam.

In an embodiment, the method comprises dispensing the foaming source and the multivalent ion source simultaneously into the liquid source into the liquid source during aeration.

In an embodiment, the aerating is selected from the group consisting of agitating, whipping, stirring, shearing, gas sparging, gas production by chemical/biochemical reaction, gas release ultrasonic treatment, etc. and combinations thereof.

In an embodiment, the mixing takes place simultaneously with the combining of the foaming source, the multivalent ion source and the liquid source.

In an embodiment, the mixing requires less than 1 minute to produce the improved quality foam.

In an embodiment, the mixing requires less than 10 seconds to product the improved quality foam.

In an embodiment, the foam is stable for more than 1 hour after the mixing.

In an embodiment, the foam is stable for more than 24 hours after the mixing.

In an embodiment, the foaming source is selected from the group consisting of one or more one powdered protein sources, liquid protein sources, milk, cream and combinations thereof.

In an embodiment, the foaming source is selected from the group consisting of dairy and non-dairy proteins (e.g. sodium caseinate), demineralized whey protein isolate product, a low mineralized whey protein isolate product and combinations thereof.

In an embodiment, the multivalent ion source is selected from the group consisting of calcium, magnesium, iron, zinc, nickel, cobalt, manganese and combinations thereof.

In an embodiment, the calcium ion is selected from the group consisting of calcium chloride, calcium bromide, calcium lactate, calcium nitrate, calcium bicarbonate, calcium acetate, calcium ascorbate, calcium gluconate, calcium glycerophosphate and combinations thereof.

In an embodiment, the multivalent ion source has a concentration ranging from about 1 mM to 20 mM.

In an embodiment, the multivalent ion source has a concentration ranging from about 2.7 mM to 10 mM.

In an embodiment, the foaming source, the multivalent ion source and the liquid source are stored separately prior to combining.

In an embodiment, the foaming source and the multivalent ion source are stored as a dry mix together prior to combining with the liquid source.

In an embodiment, the method comprises: providing a dry mix including at least one foaming source and at least one multivalent ion source; providing a liquid source separate from the dry mix; dispensing the dry mix at the same time with the liquid source as mixing/aerating, for example by whipping or shearing, to produce the stable foam.

In an embodiment, the method comprises: providing a foaming source; providing a concentrated liquid multivalent ion source; dispensing the foaming source and the concentrated liquid multivalent ion source; and simultaneously mixing/aerating during the dispensing to produce the improved quality foam.

In an embodiment, the foaming source is selected from a group consisting of a powder protein source, a concentrated liquid protein source and combinations thereof.

In an embodiment, the foaming source is stored separately from the concentrated liquid multivalent ion source prior to dispensing.

In an embodiment, the method comprises: providing a milk-based product; providing a calcium ion source; providing a liquid source separate from the calcium ion source; simultaneously dispensing the milk-based product and the calcium ion source with the liquid source; and mixing/aerating, for example by whipping or shearing during the dispensing to produce the stable foam.

In an embodiment, the liquid source is a dairy product, non-dairy product or mixture thereof.

In an embodiment, the liquid source is a coffee-based product.

An advantage of the present invention is an increase in beverage foam quality such as volume, stability and texture, of foam-containing products (e.g. cappuccino type liquid beverages) from a dispenser.

Another advantage of the present invention is to provide a beverage foam that improves the organoleptic qualities of the liquid portion of the beverage for consumers.

Still another advantage of the present invention is to provide additional nutritional values to a beverage.

Yet another advantage of the present invention is to allow a consumer or operator to customize or control the foam amount, texture and bubble size distribution of a beverage.

Another advantage of the present invention is to provide a beverage with foam properties according to a consumers preferences.

Still another advantage of the present invention is enable a beverage producer to provide high quality beverages for sale to consumers.

Yet another advantage of the present invention is to provide a dispensing system for closed powder/liquid from capsules or bulk products.

Another advantage of the present invention is to create a liquid beverage with high quality foam in a very short period of time.

Additional features and advantages of the present invention are described in, and will be apparent from, the following Detailed Description and the figures.

### BRIEF DESCRIPTION OF THE FIGURES

FIG. 1A is a graph illustrating the effect of calcium concentration (calcium lactate) on foam-to-liquid ratio (FLR).

FIG. 1B is a graph illustrating the effect of calcium concentration (calcium lactate) on stiffness of foams from de-mineralized whey protein isolate depending on if the calcium was added with the powder or with the water.

FIG. 2 is a graph illustrating the effect of calcium ion concentration (CaCl₂) on FLR of foams from de-mineralized whey protein isolate when calcium was added to the powder.

FIG. 3 is a graph illustrating the effect of calcium ion concentration (CaCl₂) on stiffness of foams from a commercial demineralized whey protein isolate when calcium was added to the powder.

FIG. 4 is a graph illustrating the effect of calcium ion concentration (CaCl₂) on stiffness of whipped, commercial skim milk powder beverages when calcium was added to the powder.

FIG. 5 is a graph illustrating the effect of the addition of a mixture of CaCl₂/de-mineralized WPI on stiffness of whipped, commercial skim milk beverages when calcium was added to the powder.

FIG. 6 is a graph illustrating the effect of calcium ion concentration (CaCl₂) on viscosity of cappuccino beverages prepared from a capsule when calcium was added to the powder.

FIG. 7 is a graph illustrating the effect of calcium ion concentration (calcium lactate) on FLR of whipped de-mineralized WPI beverages when calcium was added to the powder.

FIG. 8 is a graph illustrating the effect of calcium ion concentration (calcium lactate) on FLR of whipped whey protein concentrate beverages when calcium was added to the powder.

FIG. 9A is a graph illustrating the effect of calcium ion concentration (calcium lactate) on FLR.

FIG. 9B is a graph illustrating the effect of calcium ion concentration (calcium lactate) on stiffness of whipped sodium caseinate beverages when calcium was added to the powder.

### DETAILED DESCRIPTION OF THE INVENTION

The present invention relates to protein-cation based methods and systems that produce a foam of an improved quality, increased volume and improved texture upon agitation, mixing, aerating or shearing. In an embodiment, the method generally comprises preparing a dry mixture or solution of a multivalent cation source and protein source, reconstituting with a diluent or solution (e.g., water, flavored beverage) at the point (moment) of aerating (e.g. during whipping or shearing) to form the final foamed product having an improved quality foam such as stability and mouthfeel. It is important that calcium ion source be chemically separated from both protein and reconstituting liquid (water) sources. The multivalent cation source can be calcium ions, magnesium ions source or any suitable multivalent cations. The reconstituting solution can be any liquid in which foam is desired, or other food products (e.g. powdered coffee) can be added to or with the reconstituting solution to produce a desired beverage. The final foamed product can be a commonly consumed beverage such as hot chocolate, coffee, cappuccino, latte, macchiatto or other similar types of beverages.

The liquid source may comprise, for example, any suitable source of drinking water such as deionized water, distilled water, softened and hard water, and/or combination of thereof.

It was surprisingly found that addition of a cation source with milk protein powders or separately at the point of aerating, significantly improved foam quality through a dispenser. Specifically, in studies, reconstitution of the milk protein powders using water already containing the same cation concentration practically did not change foam quality as compared to a control foam without added cation.

The foamability of the beverage can be improved if the cation source and the protein source are not previously mixed in the reconstituting solution in advance before final whipping is achieved. In addition, the cation source is chemically separate from the protein source either by staying dry in a blend or mixture with the dry protein source or by being stored separately from the protein source if the cation or protein sources are already in a liquid form (i.e. liquid concentrate).

A preferred composition is a powdered protein source to which a calcium salt is added resulting in a powder mix that can be stored. Another approach is to use a separately kept powder and/or a liquid cation source and add it to the reconstitution solution simultaneously with the protein source in powder and/or liquid forms at the point of aeration through a dispenser. Once reconstituted with hot water at the point of aerating (e.g. by mixing, shearing, agitating, gas sparging, ultrasonic treatment, etc.), the foam volume and/or quality is of improved quality over ordinary foams.

To improve foam quality, for example, cation source alone, whey or other proteins alone, and/or dry combinations thereof could be added to milk base or non-dairy powders. It has been found that the use of a de-mineralized or low mineral whey protein isolate product plus highly water-soluble calcium salt is particularly effective. The most effective are multivalent cations, especially calcium and magnesium, from a variety of sources such as various organic and inorganic salts, oxides, hydroxides, coordinative compounds or mixtures thereof.

The present methods and compositions can be used in any suitable dispensing system such as a mixing or dispensing apparatus. For example, the dispensing apparatus can be part of a dispensing system using closed powder/liquid from capsules or bulk products. Alternatively, consumers can personally mix the multivalent cation and protein components in accordance with the present embodiments to arrive at the improved foam beverage. The methods and composition can also be advantageous for powder milk systems where added calcium or other cations will not be detrimental during storage, unlike for liquids.

Foam characteristics can be controlled by the amount of calcium added or released during processing, mixing or dispensing. For example, at pre-determined levels of cations, unique foam textures can be produced depending on the amount of cation addition. However, high levels of cations may provide undesirable foam texture (i.e. clumpy or with lumps).

One of the best sources of multivalent cation is calcium. Added calcium is also advantageous for nutritional purposes where supplementation or enrichment of the mineral (e.g. calcium or magnesium) is desired, and the method is also applicable for low-shear or whipper-less systems. If liquid systems are preferred, then calcium or other cation addition can be directed through other product streams and mixed together simultaneously at the time the liquid is dispensed or poured.

In an embodiment, adding the calcium source and protein source at the time of aerating (e.g. during dispensing and mixing, shearing or agitating, etc.) is effective. For example, the composition can be added through a powder canister via a dispensing apparatus or a consumer. Also effective is adding de-mineralized whey protein to the concentrate and then supplementing the water stream or some other source with calcium or other cation.

In an alternative embodiment, the method comprises adding a separate powder and/or a liquid cation source, preferably calcium, to a protein source in powder and/or liquid forms simultaneously to a liquid or solution at the point of aeration through a dispenser. The dispenser can be a whipping type dispenser that agitates or whips the cation source and protein source as they are being dispensed, for example, with the reconstitution liquid. Alternatively, the dispensing can be followed by mixing or agitation of the liquid composition in any suitable mixing apparatus or by a consumer for sufficient time to produce a quality foam.

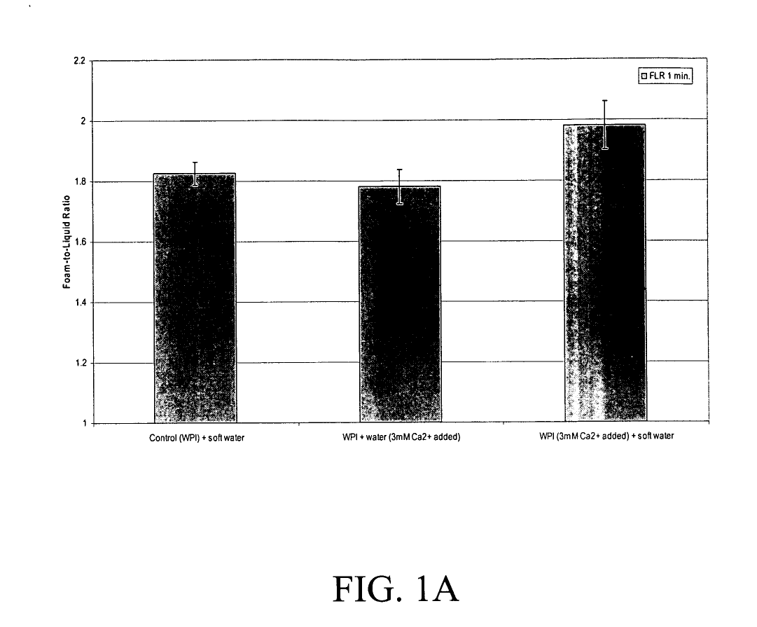

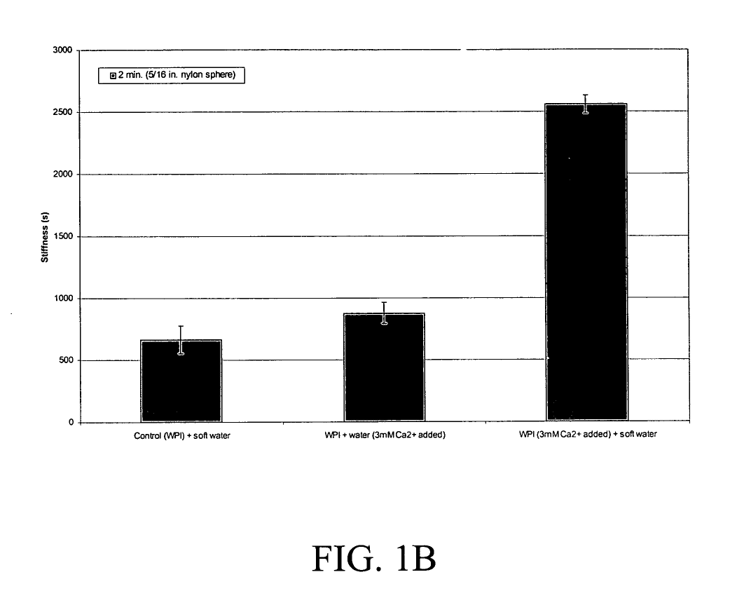

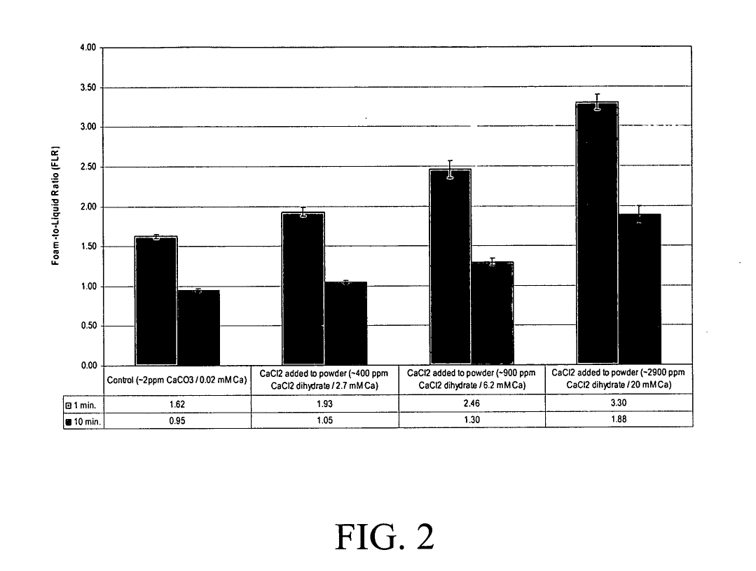

By way of example and not limitation, foam improvements for various systems are discussed below in accordance with FIGS. 1-9. FIG. 1 shows the effect of calcium concentration (calcium lactate) on (A) foam-to-liquid ratio (“FLR”) and (B) stiffness of foams from de-mineralized whey protein isolate (“WPI”) depending on if the calcium was added with the powder or with the water. In FIG. 2, calcium was added in the form of calcium chloride (CaCl₂) powder to a commercial, de-mineralized whey protein isolate powder (<0.05% Ca²⁺) at different concentrations and dispensed through a whipper dispensing system at 85° C. The final in-cup calcium concentrations were reported. Foam-to-liquid ratios (FLR) measured at 1 and 10 minutes after dispensing were increased in the presence of calcium ions, Ca²⁺.

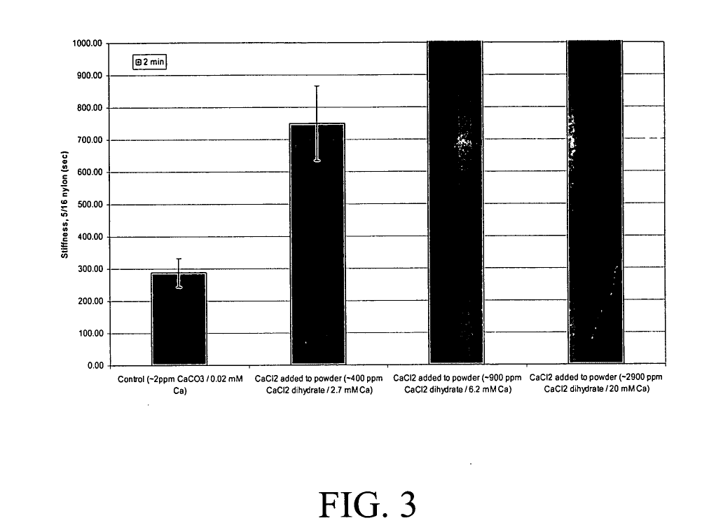

FIG. 3 reports the effect of dry CaCl₂ addition to a commercial, de-mineralized whey protein isolate on foam stiffness. The foam stiffness was measured by the 5/16-in. nylon sphere method at 2 minutes after dispensing. As shown in FIG. 3, stiffness was greatly affected by the calcium addition. In fact, in two samples with 6.2 and 20 mM of calcium ions, the nylon sphere failed to penetrate the top foam layer even after sitting overnight. Sensory evaluation was made by a panel of 5 people. As the calcium concentration increased, so did the number of small bubbles and stiffness characteristics of the foam. At high calcium concentration levels, the foam contained fine bubbles and resembled a shaving cream in appearance.

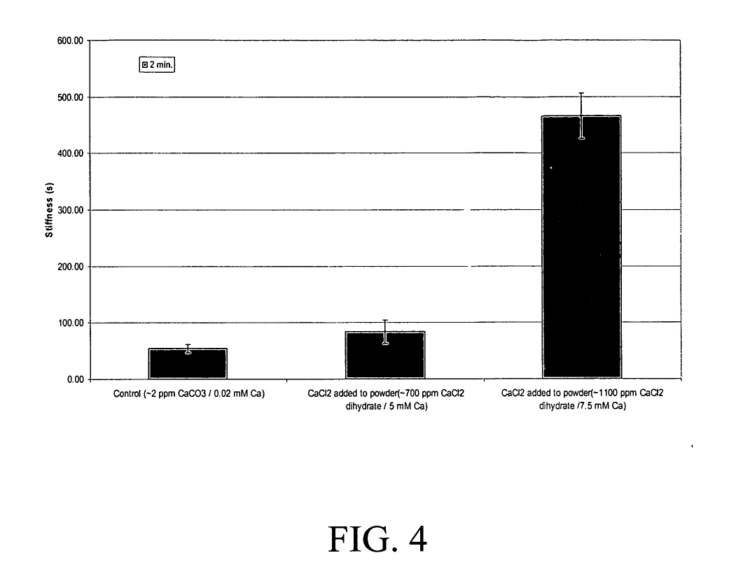

In another case, adding CaCl₂ powder to a commercial skim milk powder resulted in only a slight increase in initial foam volume, but the foam texture was improved dramatically. The stiffness measurements are shown in FIG. 4. Thus, the de-mineralized WPI/Ca²⁺ source system could be used in foam generation through a dispenser.

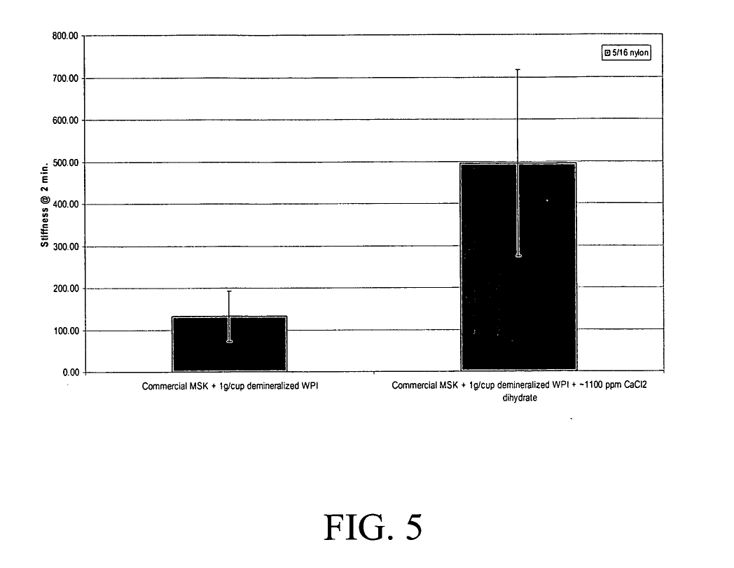

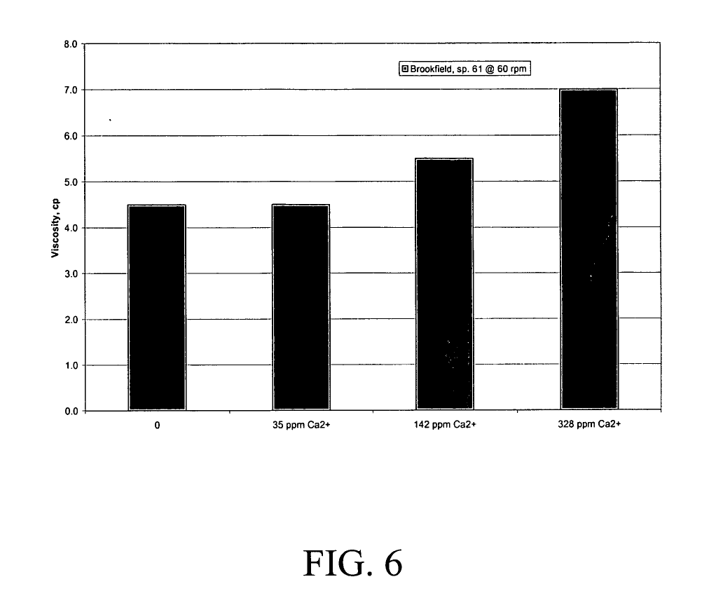

When a 10% mixture (1 g WPI+˜1100 ppm CaCl₂) of CaCl₂ powder and the de-mineralized whey protein isolate powder were added to the commercial skim milk powder (MSK), a significant increase in stiffness was also found as shown in FIG. 5. Beverage mouthfeel was also improved in correlation with an increase in liquid viscosity as shown in FIG. 6. Calcium chloride powder was also tested using a beverage capsule, and improvements were similar to those described above.

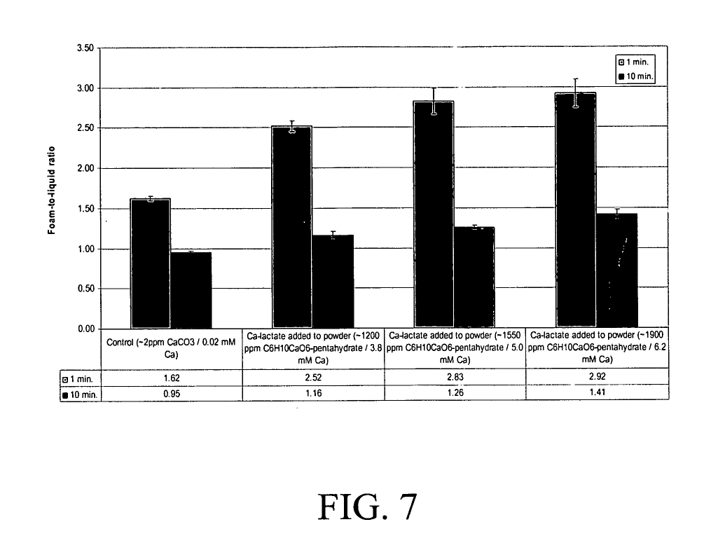

To display the effectiveness of other calcium salts, calcium lactate was added at various concentrations to a commercial, de-mineralized whey protein isolate powder. As shown in FIG. 7, improvements were observed that were similar those observed for calcium chloride. Stiffness was also enhanced with calcium lactate as the nylon sphere failed to penetrate the calcium lactate samples.

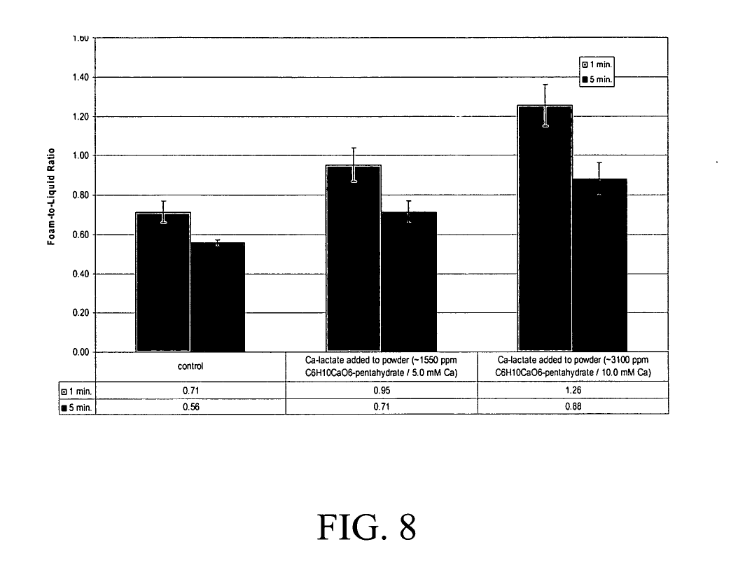

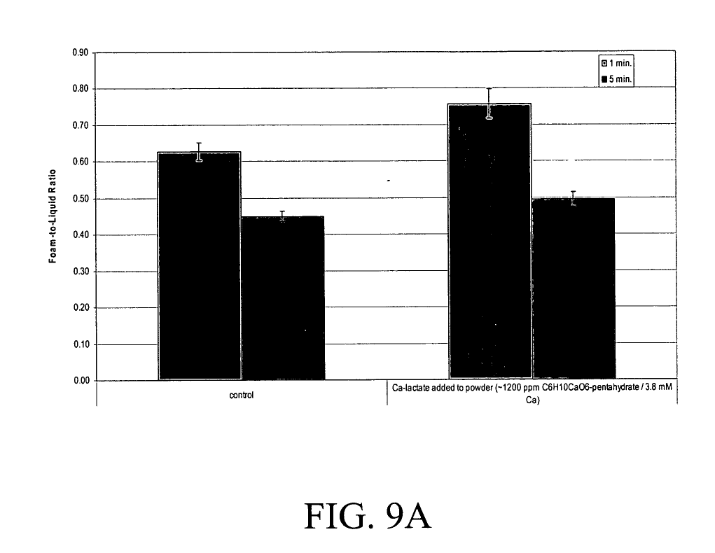

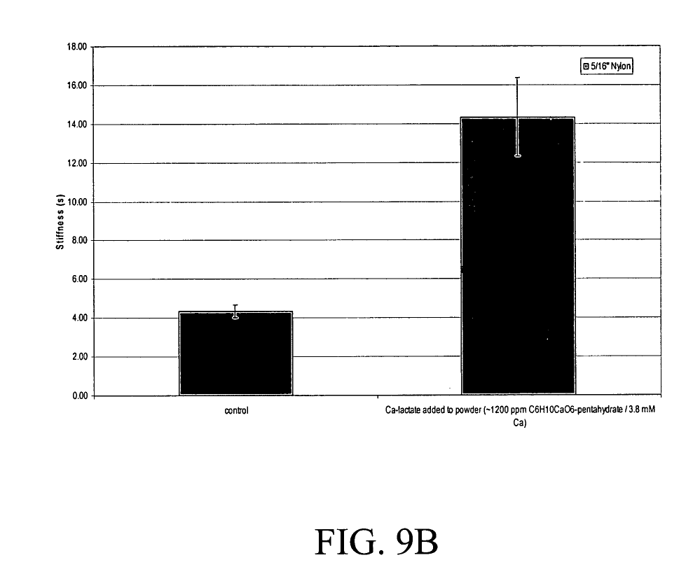

Calcium lactate was also added to other commercial powdered protein systems. As an example, results for whey protein concentrate (with ˜0.3% Ca²⁺) and sodium caseinate (with ˜0.3% Ca²⁺) are shown in FIGS. 8 and 9. In both cases, added calcium resulted in significant increases in FLR. Stiffness for whey protein concentrate and sodium casseinate (FIG. 9) was significantly increased with increasing concentrations of calcium lactate. Sensory evaluation by a panel of 5 people of foamed beverages also showed significant improvements in foam quality in such characteristics as volume, stability, mouthfeel and texture.

In an embodiment, the method comprises providing at least one foaming source; providing at least one multivalent ion source; providing a liquid source separate from the multivalent ion source; combining the foaming source, the multivalent ion source and the liquid source at the point of aerating to produce the improved quality foam. The aerating can be done, for example, by mixing, agitating, whipping, shearing, stirring, gas sparging, ultrasonic treatment or any suitable aerating/mixing method. In an embodiment, the mixing takes place simultaneously with the combining of the foaming source, the multivalent ion source and the liquid source or immediately thereafter.

In an embodiment, the system comprises at least one dry protein source; at least one dry multivalent ion source combined with the protein source to form a dry blend; and a reconstituting liquid, wherein mixing/aerating the dry blend and the reconstituting liquid generates the improved quality foam.

In an embodiment, the system comprises at least one dry protein source; at least one dry multivalent ion source stored separately from the protein source; and a reconstituting liquid, wherein mixing/aerating the protein source, the multivalent ion source and the reconstituting liquid at the point of aerating generates the improved quality foam.

In an embodiment, the system comprises at least one concentrated liquid protein source; at least one multivalent ion source stored separately from the liquid protein source; and a reconstituting liquid, wherein mixing/aerating the liquid protein source, the multivalent ion source and the reconstituting liquid at the point of aerating generates the improved quality foam. The multivalent ion source can be a dry or concentrated liquid cation source.

In an embodiment, the foaming source and the multivalent ion source is dispensed simultaneously into or with the liquid source. The dispensing can be done by any suitable dispenser. The dispenser can refer to a dispensing machine such as, for example, a coffee or cappuccino maker or can refer to a consumer stirring or combining the foaming source and multivalent ion source with a reconstituting liquid at the point of aerating by any suitable manner.

In an embodiment, the dry protein source and dry cation source can be stored together as a dry blend prior to being reconstituted. In an alternative embodiment, the dry protein source and the dry cation source can be separately stored in two separate container or packages prior to being reconstituted. In another embodiment, a liquid protein concentrate and the dry or concentrated liquid cation source can be separately stored prior to being reconstituted. The protein concentrate can be, for example, a milk-based product such as a creamer.

In an embodiment, the method can serve to improve the foaming of beverages in a dispensing machine. In another embodiment, the method can serve to improve the foam quality of a food/beverage made by a consumer by adding a dry foaming source and a dry multivalent ion source or a blend of the sources to water (also water could be added to powder(s)) and stirring simultaneously to form the foamed liquid beverage product (e.g. retail applications).

The multivalent ion source should be water soluble so that the multivalent ions are dissociated when mixed with the diluent or reconstituting solution. Preferably, the multivalent ion source is calcium ions. Water soluble source of calcium are, for instance, calcium chloride, calcium lactate or nitrate. Other compounds such as calcium phosphate or sulfate, typically used in creamers, may not work because they do not provide free calcium ions.

The multivalent ion source can be in the form of a highly concentrated solution, meaning a solution saturated in the multivalent ion source. Preferably, a dry source of the multivalent ion is used at the time of reconstitution.

It should be appreciated that in all of the embodiments any suitable aerating techniques such as mixing, shearing, gas sparging, Ventury, ultrasound or agitating can be used. For example, the mixing or shearing may require less than 1 minute to produce the improved quality foam. Preferably, the mixing or shearing requires less than 0.2 minutes to produce the improved quality foam.

The foam stability of the present embodiments may last a long time after the mixing is finished. The foam stability refers to the ability of the foam to maintain a certain percentage of its original volume and texture over time. For example, a stable foam may retain its 80% of its original volume and texture over time. Preferably, the improved foam is stable for more than 20 minutes after the mixing/aerating is complete. More preferably, the improved foam is stable for more than 24 hours after the mixing/aerating is complete.

In an embodiment, the foaming source may comprise one or more powdered protein sources, liquid protein sources, milk, cream or combinations thereof. In an embodiment, the foaming source may comprise dairy or non-dairy proteins (e.g. sodium caseinate), demineralized whey protein isolate products, low mineralized whey protein isolate products or combinations thereof. In an embodiment, the multivalent ion source may comprise any suitable ions such as calcium, magnesium, iron, zinc, nickel, cobalt, manganese or combinations thereof. In an embodiment, the calcium ion may comprise calcium chloride, calcium bromide, calcium lactate, calcium nitrate, calcium bicarbonate, calcium acetate, calcium ascorbate, calcium gluconate, calcium glycerophosphate or combinations thereof.

It should be appreciated that any suitable amount of the multivalent ion source may be used in the present embodiments. Preferably, the maximum amount of multivalent cation, such as calcium, added should not exceed 800 ppm (10 mM) in the final solution. Most preferably the amount should range of from 80 ppm to 400 ppm. Generally, if the calcium concentration is higher, it produces lumps in the product. Nevertheless, any suitable concentration of the multivalent ion source in the final product may be used. Preferably, the multivalent ion source has a concentration ranging from about 1 mM to 20 mM. More preferably, the multivalent ion source has a concentration ranging from about 2.7 mM to 10 mM.

### EXAMPLES

By way of example and not limitation, the following examples are illustrative of various embodiments of the present invention and further illustrate experimental testing conducted in accordance with embodiments of the present invention.

### Example 1

A cappuccino type beverage was prepared using a conventional dispenser (Bravilor Bonomat −20) by dissolving 7 g of de-mineralized whey protein isolate powder in 150 g of de-ionized water. The beverage was dispensed at normal operation conditions using 85° C.

The beverage obtained had a homogeneous liquid phase and high foam-to-liquid ratio (FLR=˜1.6 measured at 1 min after dispensing). Further, the foam was stable and stiff, and with desirable appearance comprising uniformly distributed small bubbles. Foam stiffness expressed in seconds (measured by the “sphere” test using a 5/16-in nylon ball at 2 min after dispensing) was ˜700 s. Viscosity of liquid part of the beverage was 1.3 cP.

Foam and liquid mouthfeel were judged by a taste panel of 5 people. The foam and liquid mouthfeel/texture was found to be acceptable.

### Example 2

A cappuccino beverage was prepared under conditions provided by Example 1 but using water with added calcium lactate, pentahydrate. Calcium concentration in the final beverage was 150 ppm.

The beverage with a homogeneous liquid phase, high foam-to-liquid ratio, and with a uniform distribution of small bubbles was obtained. Foam properties were found to be very similar to that from Example 1.

Foam and liquid organoleptic properties or mouthfeel were judged by a taste panel of 5 people. The foam and liquid mouthfeel/texture was found to be similar to those from Example 1.

### Example 3

A cappuccino beverage was prepared under conditions provided by Example 1 but using de-mineralized whey protein isolate powder with added calcium lactate, pentahydrate. Calcium concentration in the final beverage was 150 ppm.

The beverage obtained had a homogeneous liquid phase and very high foam-to-liquid ratio. Further, the foam was stable and stiff, and with desirable appearance comprising uniformly distributed small bubbles.

Foam and liquid mouthfeel were judged by a taste panel of 5 people. The foam and liquid mouthfeel/texture was found to be improved as compared to those from Example 1.

The improvements in foam and liquid mouthfeel as compared to the examples above were also confirmed by analytical characterization. Thus, foam-to-liquid ratio increased from ˜1.6 to ˜2.0, and foam stiffness from ˜700 s to ˜2'500 s as compared to Example 1 and Example 2. In addition, mouthfeel of the liquid part of the beverage was improved as compared to that from Example 1. This was found to be in a good correlation with viscosity data, 2.5 vs. 1.3 cP.

### Example 4

A cappuccino beverage was prepared under conditions provided by Example 1 but using de-mineralized whey protein isolate powder with added calcium chloride. Calcium concentration in the final beverage was 150 ppm.

The beverage obtained had a homogeneous liquid phase and very high foam-to-liquid ratio. Further, the foam was stable and stiff, and with desirable appearance comprising uniformly distributed small bubbles. Foam properties were very close to that of Example 3.

Sensory evaluation of foam was made by a taste panel of 5 people. The foam mouthfeel/texture was found to be acceptable.

### Example 5

A cappuccino beverage was prepared under conditions provided by Example 1 but using de-mineralized whey protein isolate powder with added calcium chloride. Calcium concentration in the final beverage was 800 ppm.

The beverage with a homogeneous liquid phase and very high foam-to-liquid ratio and stiff foam were observed., i.e. FLR=˜3.4, and stiffness˜more than 50,000 sec. Thus, physical properties of the foam were significantly improved as compared to Example 4.

Sensory evaluation was made by a panel of 5 people. Foam mouthfeel was undesirable (lumpy).

### Example 6

A cappuccino type beverage was prepared using a conventional single-serve dispenser (Allora). Capsule contained a mixture of de-mineralized whey protein isolate powder and calcium chloride. The beverage was dispensed at normal operation conditions using 85° C. Calcium concentration in the final beverage was 150 ppm.

Foam quality was similar to that prepared by using a mechanical whipper (Bravilor-Bonomat).

### Example 7

A cappuccino beverage was prepared under conditions provided by Example 1 but using mixture of commercial skim milk (90%) and whey protein isolate (10%) powders.

The beverage with a homogeneous liquid phase, high foam-to-liquid ratio, and with a uniform distribution of small bubbles was obtained. Foam stiffness was ˜120 s.

### Example 8

A cappuccino beverage was prepared under conditions provided by Example 7 but using mixture of commercial skim milk powder (˜90%), whey protein isolate (˜10%) but with added calcium chloride. Calcium, concentration in the final beverage was 150 ppm.

The beverage with a homogeneous liquid phase, very high foam-to-liquid ratio, and with a uniform distribution of small bubbles was observed. Foam stiffness was significantly improved as compared to that from Example 7, i.e. 500 vs. 120 s.

In accordance with various embodiments of the present invention, more stable and stiffer foams with more uniform bubble size distributions were generated in samples with added calcium lactate (varying up to 20 mM as calcium ions). No change in foam taste (especially bitterness) was detected even for very high levels of calcium lactate.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method for generating an improved quality foam for a beverage, the method comprising:
providing at least one foaming source;
providing at least one multivalent ion source;
providing a liquid source separate from the multivalent ion source;
combining the foaming source, the multivalent ion source and the liquid source and aerating to produce the improved quality foam.

2. The method of claim 1 comprising dispensing the foaming source and the multivalent ion source simultaneously into the liquid source during aeration.

3. The method of claim 1, wherein the aerating is selected from the group consisting of agitating, mixing, whipping, stirring, shearing, gas sparging, gas production by chemical/biochemical reaction, gas release ultrasonic treatment and combinations thereof.

4. The method of claim 3, wherein the aerating takes place simultaneously with the combining of the foaming source, the multivalent ion source and the liquid source.

5. The method of claim 4, wherein the mixing requires less than 1 minute to produce the improved quality foam.

6. The method of claim 4, wherein the mixing requires less than 0.2 minute to product the improved quality foam.

7. The method of claim 4, wherein the foam is stable for more than 20 minutes after the mixing.

8. The method of claim 4, wherein the foam is stable for more than 24 hours after the mixing.

9. The method of claim 1, wherein the foaming source is selected from the group consisting of powdered protein sources, liquid protein sources, milk, cream and combinations thereof.

10. The method of claim 1, wherein the foaming source is selected from the group consisting of dairy proteins, non-dairy proteins, demineralized whey protein isolate products, low mineralized whey protein isolate products and combinations thereof.

11. The method of claim 1, wherein the multivalent ion source is selected from the group consisting of calcium, magnesium, iron, zinc, nickel, cobalt, manganese and combinations thereof.

12. The method of claim 5, wherein the calcium ion is selected from the group consisting of calcium chloride, calcium bromide, calcium lactate, calcium nitrate, calcium bicarbonate, calcium acetate, calcium ascorbate, calcium gluconate, calcium glycerophosphate and combinations thereof.

13. The method of claim 5, wherein the multivalent ion source has a concentration ranging from about 1 mM to 20 mM.

14. The method of claim 1, wherein the multivalent ion source has a concentration ranging from about 2.7 mM to 10 mM.

15. The method of claim 1, wherein the foaming source, the multivalent ion source and the liquid source are stored separately prior to combining.

16. The method of claim 1, wherein the foaming source and the multivalent ion source are stored as a dry mix together prior to combining with the liquid source.

17. A method for generating a stable foam for a beverage, the method comprising:
providing a dry mix including at least one foaming source and at least one multivalent ion source;
providing a liquid source separate from the dry mix;
dispensing the dry mix with the liquid source; and
aerating simultaneously while the dry mix and liquid source are dispensed to produce the stable foam.

18. A method for generating a foam having an improved stability and mouthfeel, the method comprising:
providing a foaming source;
providing a concentrated liquid multivalent ion source;
dispensing the foaming source and the concentrated liquid multivalent ion source; and
simultaneously aerating during the dispensing to produce the improved quality foam.

19. The method of claim 18, wherein the foaming source is selected from a group consisting of powder protein sources, concentrated liquid protein sources and combinations thereof.

20. The method of claim 19, wherein the foaming source is stored separately from the concentrated liquid multivalent ion source prior to dispensing.

21. A method for generating a stable foam for a beverage, the method comprising:
providing a milk-based product;
providing a calcium ion source separate from the milk-based product if the product in liquid form;
providing a liquid source separate from the calcium ion source;
simultaneously dispensing the milk-based product and the calcium ion source with the liquid source; and
aerating during the dispensing to produce the stable foam.

22. A method for generating a stable foam for a beverage, the method comprising:
providing a non-dairy based foaming product;
providing a calcium ion source separate from the non-dairy based foaming product;
providing a liquid source separate from the calcium ion source;
simultaneously dispensing the non-dairy based foaming product and the calcium ion source with the liquid source; and
aerating during the dispensing to produce the stable foam.

23. A method for generating a stable foam for a beverage, the method comprising:
providing a foaming source in a liquid form;
providing a calcium ion source separate from the foaming source;
providing a liquid source separate from the calcium ion source;
simultaneously dispensing the foaming source and the calcium ion source with the liquid source; and
aerating during the dispensing to produce the stable foam.

24. The method of claim 23, wherein the foaming source or liquid source is a coffee-based product.

25. A system for generating an improved quality foam for a beverage, the system comprising:
at least one dry protein source;
at least one dry multivalent ion source combined with the protein source to form a dry blend; and
a reconstituting liquid, wherein simultaneously aerating the dry blend and the reconstituting liquid generates a liquid beverage having the improved quality foam.

26. A system for generating an improved quality foam for a beverage, the system comprising:
at least one dry protein source;
at least one dry multivalent ion source stored separately from the protein source; and
a reconstituting liquid, wherein simultaneously aerating the protein source, the multivalent ion source and the reconstituting liquid generates a liquid beverage having the improved quality foam.

27. A system for generating an improved quality foam for a beverage, the system comprising:
at least one concentrated liquid protein source;
at least multivalent ion source stored separately from the liquid protein source; and
a reconstituting liquid, wherein simultaneously aerating the liquid protein source, the multivalent ion source and the reconstituting liquid generates a liquid beverage having the improved quality foam.
